(19) United States
(12) Patent Application Publication
(10) Pub. No.: US 2011/0291582 A1
(43) Pub. Date: Dec. 1, 2011

(54) LIGHT EMITTING DIODE LIGHTING DEVICE DRIVEN BY A UNIFORM ALTERNATING CURRENT

(76) Inventors: Tao-Chin WEI, Taipei City (TW); Yuan-Ping Liu, Taipei (TW)

(21) Appl. No.: 12/888,016

(22) Filed: Sep. 22, 2010

(30) Foreign Application Priority Data
May 25, 2010 (TW) 099116652

(51) Int. Cl. H05B 41/36

(52) U.S. Cl. 315/254; 315/250; 315/258

(57) ABSTRACT

The invention is disclosed a lighting device using an alternating current to drive light emitting diodes (LEDs). The lighting device uses at least two parallel-connected LED modules. In front of each LED module has connected to a current balancing unit in series that has same capacitance or inductance. The LED module comprises a first polarity LED bar and a second polarity LED bar connected in parallel. The LED module receives an alternating current voltage from the current balancing unit, which alternatively drive the first polarity LED bar and the second polarity LED bar. The light device uses different impedances of the current balancing unit and the LED to provide smooth and uniform current to the LED module and achieves a stable luminance.

### FIELD OF THE INVENTION

The present invention relates to a LED lighting device using an alternating current to drive light emitting diodes (LEDs), especially to a balancing LED lighting device driven by an alternating current, which makes uniform current through each LED bar by current balancing units.

### BACKGROUND OF THE INVENTION

A light emitting diode (LED) has features of quick response, energy efficiency, high safety, longer life expectancy and small size. LED is popularly used in different electrical lighting devices. In order to border LED application in different fields, many manufacturers have already developed different light-excited materials to improve lighting efficiency and used an LED-based backlight module or panel to replace a conventional cold cathode fluorescent lamp (CCFL) associated device.

Generally, a backlight module uses multiple paralleled LED lamps as lighting sources, which is driven by a direct current. However, an individual LED lamp comprises multiple line-up LED bulbs. These LED bulbs may have different brightness because the current pass through each LED bulb not always equally to each other due to little different in electrical property in each LED bulb. In order to control the current pass through each LED lamp are the same to emit equal brightness, a controller can be set on the LED lamp. However, above mentioned method will increase cost of production.

### SUMMARY OF THE INVENTION

An objective of the present invention is to provide a Light emitting diode (LED) lighting device that is driven by an alternating current. The LED lighting device has uniform current through each LED bar that emits light at a substantially uniform level of brightness.

An LED lighting device in accordance with the present invention comprises at least two LED modules and at least two current balancing units. Each of the comprising a first polarity LED bar and a second polarity LED bar connected in parallel. Each of the current balancing units being electrically connected to individual the LED module. The current balancing unit receives a sinusoidal AC voltage to alternative driving the first LED bar and the second LED bar.

### BRIEF DESCRIPTIONS OF THE DRAWINGS

FIG. 1 is a circuit scheme of an LED lighting device in accordance with the present invention;

FIG. 2 is a scheme of a half bridge resonant circuit in the lighting device in accordance with the present invention;

FIG. 3 is a scheme of a full bridge resonant circuit in the lighting device in accordance with the present invention;

FIG. 4 is a first embodiment of an LED lighting device with two current balancing inductors;

FIG. 5 is a second embodiment of an LED lighting device with two current balancing inductors;

FIG. 6 is a third embodiment of an LED lighting device with two current balancing inductors;

FIG. 7 is a first embodiment of an LED lighting device with two current balancing capacitors;

FIG. 8 is a second embodiment of an LED lighting device with two current balancing capacitors;

FIG. 9 is a third embodiment of an LED lighting device with two current balancing capacitors; and

FIG. 10 is a scheme of an LED lighting device with a transformer.

### DETAILED DESCRIPTION OF THE PRESENT INVENTION

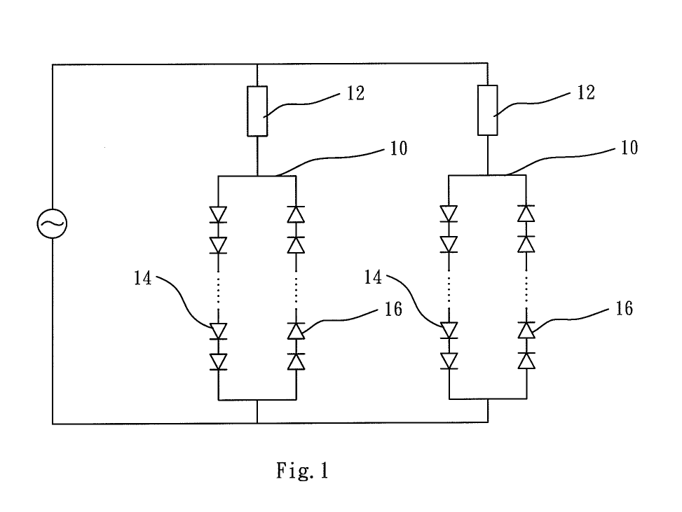

With reference to FIG. 1 that illustrates a circuit scheme of the present invention. A LED lighting device comprises at least two light emitting diodes (LED) module 10 and at least two current balancing units 12. Each LED module 10 comprises a first polarity LED bar 14 and a second polarity LED bar 16 connected in parallel. Polarities of the first polarity LED bar 14 and the second polarity LED bar 16 are reversed, wherein the Each LED bar has multiple LED components connected in series. The two current balancing units 12 optionally are two current balancing inductors with same inductance values or two current balancing capacitors with same capacitance values. Each current balancing unit 12 is electrically connected to a LED module 10. The current balancing unit 12 and receives a sinusoidal alternating current (AC) voltage, whereby using AC voltage to light the first polarity LED bar 14 and the second polarity LED bar 16, respectively. Because of the impendence of the current balancing unit 12 is 3 times greater than the LED component, and therefore the current through the first polarity LED bar 14 and the second polarity LED bar 16 is mainly decided by the crossed voltage crossed to of the current balancing unit 12 and the LED module 10. Thus, the impendence difference of each LED bar can be neglected and the current through each LED bar are same so that each LED bar emits balancing brightness. Regarding to prior art, the present invention successfully solve the unstable luminance and color-difference because of the each LED having different amount current through LED.

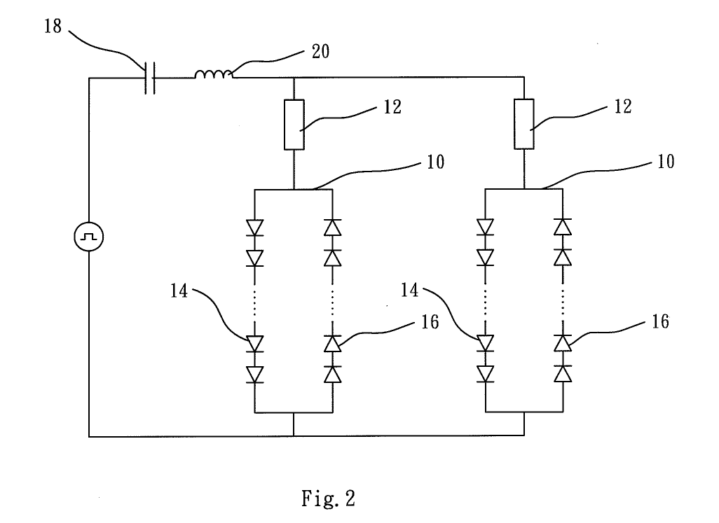

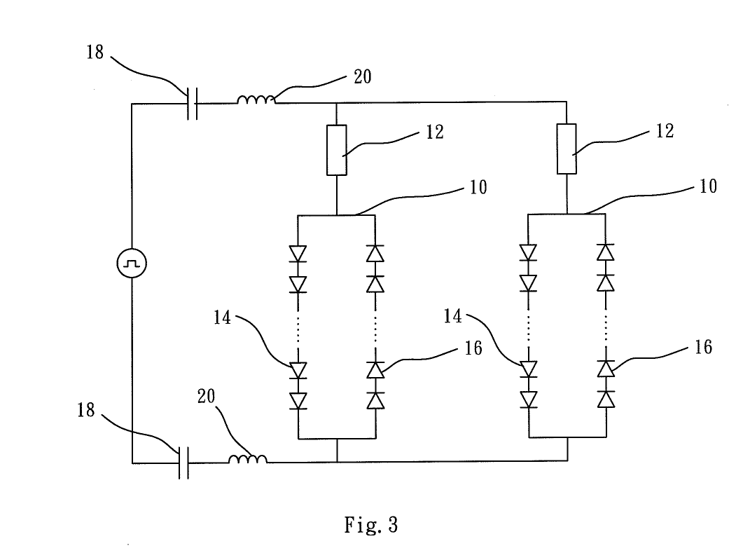

With reference to FIG. 2, the FIG. 2 is different to the FIG. 1 by adding a half bridge resonant circuit. The half bridge resonant circuit has a resonant capacitor 18 and a resonant inductor 20. The resonant inductor 20 is serial-connected between the resonant capacitor 18 and the current balancing unit 12. The half bridge resonant circuit receives an alternating pulsing signal from a high frequency square input. The fundamental frequency of the alternating pulsing signal is similar to the resonant frequency of the resonant capacitor 18 and resonant inductor 20. Therefore, the resonant capacitor 18 and the resonant inductor 20 filters out multiple high frequency components of the input signal to reduce the circuit losses and electromagnetic interference and generate a sinusoidal or trapezoidal alternating voltage. The alternating current passes through the current balancing unit 12 and generated a half-cycled positive and negative voltage that can be used to light the first polarity LED bar 14 and the second polarity LED bar 16 with forward-bias, respectively. In summary, the lighting device in accordance with the present invention uses input current to alternatively light the LEDs. As shown in FIG. 3, regardless of using a half bridge resonant circuit to drive the lighting device as mentioned above, the lighting device in accordance with the present invention further comprises a full bridge resonant circuit. The full bridge resonant circuit comprises two resonant capacitors 18 and two resonant inductors 20. The two inductors 20 are serial connected to the current balancing unit 12 respectively, and each then connected to the resonant capacitor 18 in series. The full bridge resonant circuit can be applied to a large scale panel or television wall using multiple LED modules 10 cascaded in parallel.

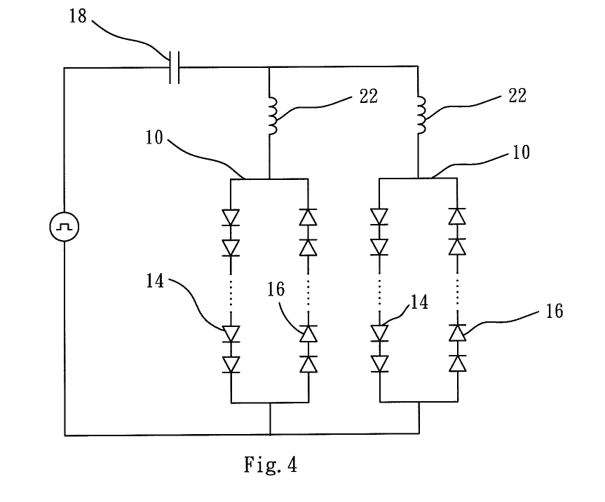

As above mentioned, the at least two current balancing units 12 optionally are two current balancing inductors with equal inductance value or two current balancing capacitors with same capacitance value. With reference with FIG. 4, at least two current balancing units 12 are two current balancing inductors 22 and are used in the lighting device in accordance with the present invention. The two current balancing inductors 22 are connected between the resonant capacitor 18 and the LED module 10. The resonant capacitor 18 and current balancing inductor 22 form a resonant circuit with a filtering function. In this embodiment, two LED modules 10 are parallel connected. Each LED module 10 cascades a current balancing inductor 22 in series and each current balancing inductor 22 has same inductance value. Each LED module 10 has the first polarity LED bar 14 and the second polarity LED bar 16 connected in parallel. Also, the amount of the current balancing inductor 22 with multiple parallel-connected LED modules 10 can be increased to a desired demand (i.e. making a backlight source of a large scale display.). The resonant circuit receives an alternating current pulsing signal from a high frequency input. The resonant capacitor 18 and the current balancing inductor 22 generate a sinusoidal or trapezoidal alternating voltage by resonating and filtering the high frequency components out. Since the impendence of the current balancing inductor 22 should be 1.5 times larger the impendence of the LED components, the current through the first polarity LED bar 14 and the second polarity LED bar 16 has mainly determined by a crossed voltage of the current balancing inductor 22 and the LED module 10. When multiple parallel-connected of the LED modules 10 have been driven and the inductance values of current balancing inductors 22 are fixed, the current through each LED bar will be the same. In other words, if the half-cycled positive and negative voltage of the alternating current voltage drive the first polarity LED bar 14 and the second polarity LED bar 16, the current through each LED bar has same amount of current that achieves same luminant output. Regarding to prior art, the present invention successfully solve the unstable luminance and color-difference because of having different amount current through LED.

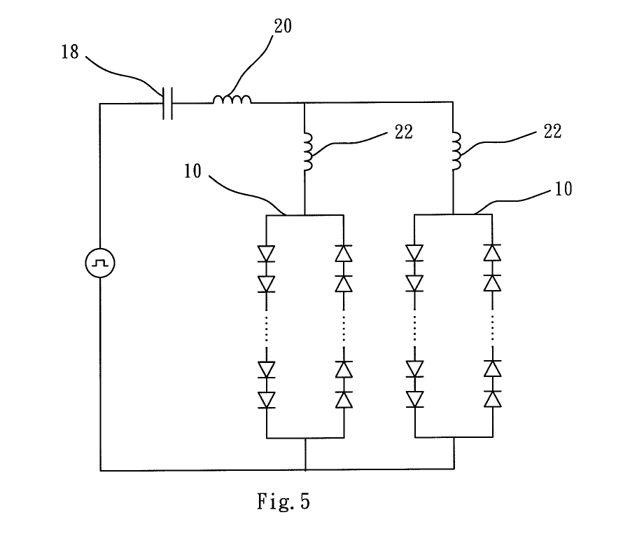

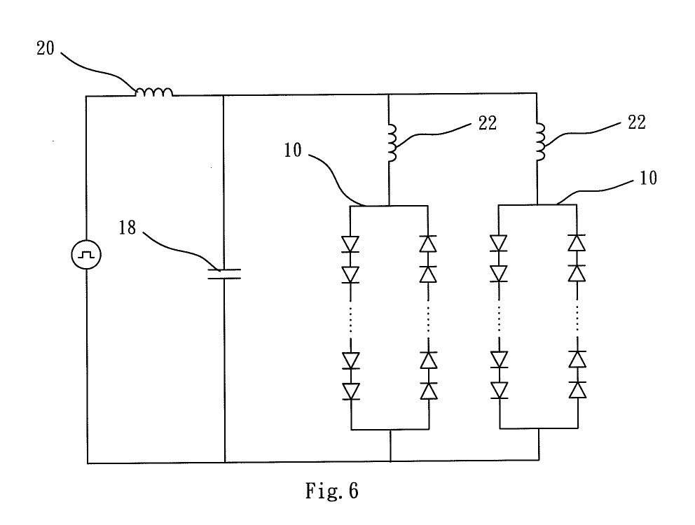

With reference to FIG. 5, compare to FIG. 4, FIG. 5 is further comprises a resonant inductor 20 and resonant capacitor 18. The resonant inductor 20, the resonant capacitor 18 and the current balancing inductor 22 form a resonant circuit having a filtering function. Since equivalent inductance value of the current balancing inductor 22 decreases significant when the numbers of paralleled LED modules 10 are increased during resonant that makes the resonant capacitor 18 adjust resonant frequencies harder and harder. Therefore, after adding the resonant inductor 20, the resonant frequencies are adjustable in a bigger range by adjusting the inductance value of the resonant inductor 20. Please also refer to FIG. 6, which change the connections of the resonant capacitor 18 and the resonant inductor 20 from series to parallel. Since series-connection of the resonant circuit has no boost voltage capability. Using parallel connection of the resonant circuit is able to make the circuit to have boost voltage capability.

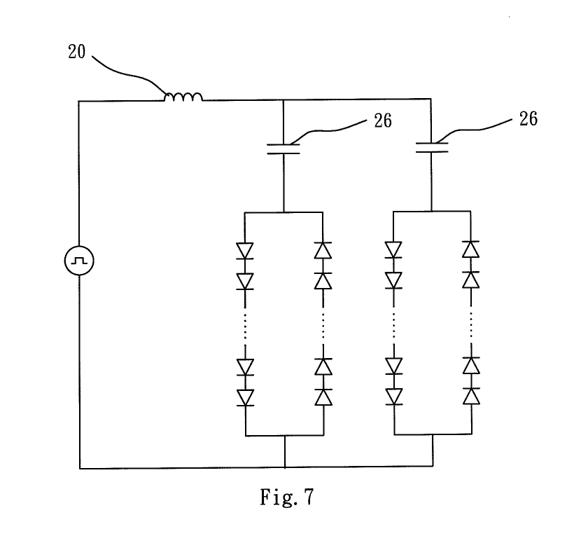

With reference to FIG. 7, is different from FIG. 4. The FIG. 4, replacing the two current balancing inductors 22 and the resonant capacitors 18 by two current balancing capacitors 26 and the resonant inductors 20 respectively, convert resonant capacitor to resonant inductor. Using current balancing capacitors 26 will reduce the use of inductors from multiple inductors to one inductor. Since the inductor is a wiring component that has higher initial cost than others. Therefore, using the current balancing capacitor 26 as a current balancing unit can reduce the manufacturing cost and enhance product competitiveness.

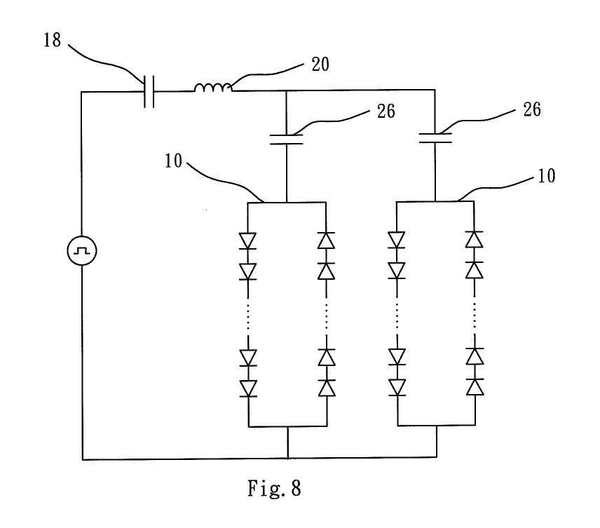

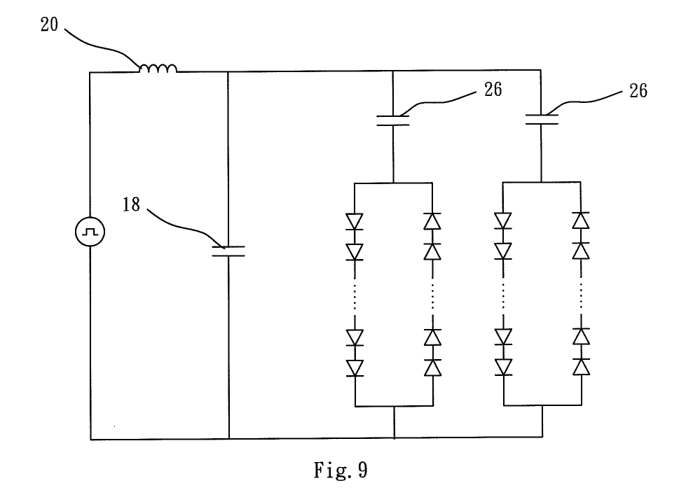

With reference to FIG. 8, FIG. 8 is different from FIG. 7 by further comprising a resonant capacitor 18 cascaded to the resonant inductor 20. The resonant capacitor 18, the resonant inductor 20 and current balancing capacitor 26 create a resonant circuit with a filtering function. Since equivalent capacitance value of the current balancing capacitors 26 increase significant when the numbers of paralleled LED modules 10 are increased during resonant that makes resonant frequencies adjusted harder. Therefore, after adding the resonant capacitor 18, the resonant frequencies are adjustable in a larger range by adjusting the capacitance value of the resonant capacitor 18. Please also refer to FIG. 9, which change the connections of the resonant capacitor 18 and the resonant inductor 20 from series to parallel. Since series resonant circuit has no boost voltage capability. Using parallel resonant circuit is able to make the circuit to have boost voltage capability.

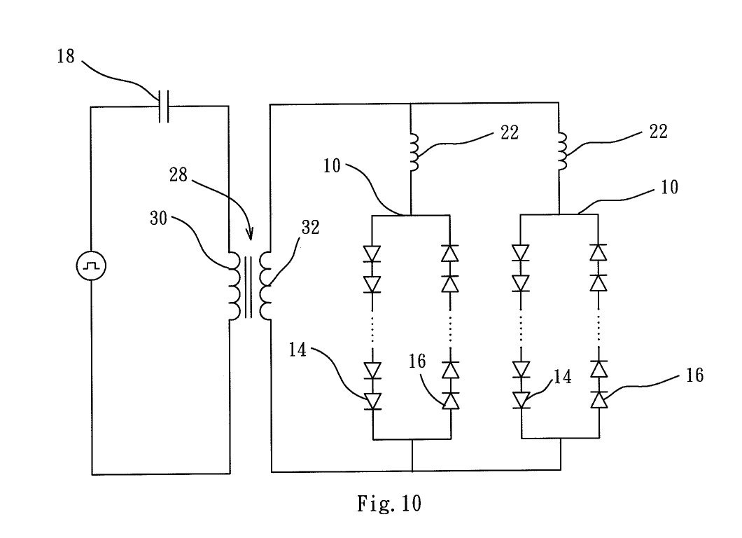

Above mentioned embodiments may further comprise a transformer regardless the resonant circuit of the alternating current driven lighting device is connected in series or in parallel. The transformer is used to transform voltage and isolate signal (i.e. high frequency signal of noises etc.). Using the circuit scheme FIG. 4 thereof to have a transformer as an example. The FIG. 10 illustrates a transformer 28 has a primary side 30 and a secondary side 32. Using the primary side 30 of the transformer 28 to be a resonant inductor, this forms a resonant circuit by connecting the resonant capacitor 18 with a filtering function in parallel. The two parallel-connected LED modules 10 are disposed in secondary side 32 and each LED modules 10 connects with a current balancing inductor 22 in parallel. The resonant circuit generates the alternating current voltage by filtering an alternating current pulsing signal after the resonant circuit receiving the alternating current pulsing signal. When the primary side 30 had input a positive voltage of the alternating current voltage, the alternating current voltage also input a positive voltage into the secondary side 32. In other words, when input voltage is in a positive half-cycle, an upper end of the secondary side 32 of the transformer 28 is positive and lower end is negative. The transformer 28 transforms the voltage and isolates the high frequency component of the signal, and then alternating current flow through the current balancing inductor 22 to the first polarity LED bar 14, which drives the first polarity LED bar 14 to emit light in forward-bias. When input voltage is in a negative half-cycle, the upper end of the secondary side 32 of the transformer 28 is negative and the lower end is positive. The transformer 28 transforms the voltage and isolates the high frequency component of the signal, and then alternating current through the current balancing inductor 22 to the second polarity LED bar 16 that drives, which drives the second polarity LED bar 16 to emit light in forward-bias. The present invention achieves the objective of alternatively driving the LEDs by alternating current input. Further, Current through the first polarity LED bar 14 and the second polarity LED bar 16 has mainly determined by voltage crossed to the current balancing inductor 22 and the LED module 10. When multiple parallel-connected of the LED modules 10 have been driven and the inductance values of current balancing inductors 22 are fixed, the current through each LED bar will be same to provide constant current to the lighting device with an alternating current driving capability.

People skilled in the art will understand that various changes, modifications and alterations in form and details may be made without departing from the spirit and scope of the invention.

What is claimed is:

1. A light emitting diode (LED) lighting device driven by a uniform alternating current, comprising:
at least two LED modules, each of the LED modules comprising a first polarity LED bar and a second polarity LED bar coupled in parallel; and
at least two current balancing units, each of the current balancing units being electrically connected to individual the LED module, receiving a sinusoidal AC voltage to alternative driving the first LED bar and the second LED bar.

2. The LED lighting device as claimed in claim 1, wherein the two current balancing units are two current balancing inductors.

3. The LED lighting device as claimed in claim 1, wherein the two current balancing units are two current balancing capacitors.

4. The LED lighting device as claimed in claim 1, further comprising a resonant circuit, the resonant being electrically connected to the two current balancing units, the resonant receiving an square wave pulsing signal, resonating the square wave pulsing signal to form the alternatively voltage and providing the alternatively voltage to the two current balancing units.

5. The LED lighting device as claimed in claim 4, wherein the resonant circuit is a half bridge resonant circuit that comprises a resonant capacitor and a resonant inductor, the resonant inductor is connected to the resonant capacitor and the two current balancing units in series.

6. The LED lighting device as claimed in claim 4, wherein the resonant circuit is a half bridge resonant circuit that comprises a resonant capacitor and a resonant inductor, the resonant inductor is connected to the resonant capacitor in series and then to the two current balancing unit in parallel.

7. The LED lighting device as claimed in claim 4, wherein the resonant circuit is a full bridge resonant circuit that comprises two resonant capacitors and two resonant inductors, each resonant inductor is connected respectively to the resonant capacitor and the two current balancing units in series.

8. The LED lighting device as claimed in claim 4, wherein the resonant circuit is a full bridge resonant circuit that comprises two resonant capacitors and two resonant inductors, each resonant inductor is connected to the resonant capacitor in series first and then to the LED modules in parallel.

9. The LED lighting device as claimed in claim 4, further comprising a transformer that comprises a primary side and a secondary side, wherein the resonant circuit is located on the primary side, the two current balancing units and the two LED modules is located on the secondary side.

10. The LED lighting device as claimed in claim 1, wherein the AC voltage output in positive half cycle is used to drive the first polarity LED bar, which in negative half cycle is used to drive the second polarity LED bar.
